(19) United States
(12) Patent Application Publication
(10) Pub. No.: US 2009/0211144 A1
(43) Pub. Date: Aug. 27, 2009

(54) Jig lure assembly

(76) Inventor: John F. Murphy, Imlay City, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/070,955

(22) Filed: Feb. 22, 2008

(51) Int. Cl. A01K 85/12; A01K 85/00

(52) U.S. Cl. 43/42.19; 43/42.39; 43/42.15

(57) ABSTRACT

A jig lure assembly (10) including a fishing leader line (12), a vertical attachment portion (18), and a horizontal shank portion (20). The horizontal shank portion (20) is positioned in a substantially perpendicular manner with respect to the vertical attachment portion (18). In addition, the jig lure assembly (10) has a curved hook portion (22) extending longitudinally from an end of the horizontal shank portion (20). Furthermore, the jig lure assembly (10) includes a generally spherical weight (28) enclosing at least a portion of the vertical attachment portion (18) and the horizontal shank portion (20) such that the vertical attachment portion (18) extends upwardly through the weight (28). A bead stopper (44) is fixedly mounted to the leader line (12). In addition, a plurality of beads (46) and a spinner blade (60) are rotatably and slidably mounted to the leader line (12) between the stopper (44) and the weight (28) such that jigging of the lure assembly (10) causes the spinner blade (60) to rotate about the leader line (12).

### BACKGROUND OF THE INVENTION

1. Field of the Invention

The invention relates to a jig-type fishing lure assembly.

2. Background Art

Prior art references include U.S. Patent Application Publication No. 2006/0201050 A1 and U.S. Pat. Nos. 6,772,553; 5,394,636; 5,182,876; 4,862,629; 3,918,192; 3,828,463; 3,579,892; and 2,238,292.

### SUMMARY OF THE INVENTION

In a first embodiment a jig lure assembly is provided including a fishing leader line, a vertical attachment portion for attaching the jig lure assembly to the fishing leader line, and a horizontal shank portion. The horizontal shank portion is positioned in a substantially perpendicular manner with respect to the vertical attachment portion. The jig lure assembly has a curved hook portion extending longitudinally from an end of the horizontal shank portion. Furthermore, the jig lure assembly includes a generally spherical weight enclosing at least a portion of the vertical attachment portion and the horizontal shank portion such that the vertical attachment portion extends upwardly through and away from the weight. A bead stopper is fixedly mounted to the fishing leader line. In addition, a plurality of beads and a spinner blade are rotatably and slidably mounted to the leader line. The plurality of beads and the spinner blade are between the stopper and the weight such that jigging of the lure assembly causes the spinner blade to rotate about the fishing leader line above the weight and hook portion.

The objects, features and advantages of the present invention are readily apparent from the following detailed description of the preferred embodiment when taken in connection with the drawings.

### BRIEF DESCRIPTION OF THE DRAWINGS

FIG. 1 is a side elevational view illustrating a jig lure assembly constructed in accordance with the invention;

FIG. 2a is a side elevational view of the jig lure assembly of FIG. 1 illustrating downward vertical movement of the jig lure assembly during use;

FIG. 2b is a side elevational view illustrating the jig lure assembly of FIG. 1 disposed at a bottom surface of a body of water;

FIG. 2c is a side elevational view of the jig lure assembly of FIG. 1 as the jig lure assembly ascends;

FIG. 2d is a side elevational view illustrating upward vertical movement of a plurality of beads and a spinner blade of the jig lure assembly of FIG. 1; and

FIG. 2e is a side elevational view illustrating downward vertical movement of the plurality of beads and the spinner blade.

### DETAILED DESCRIPTION OF THE PREFERRED EMBODIMENT(S)

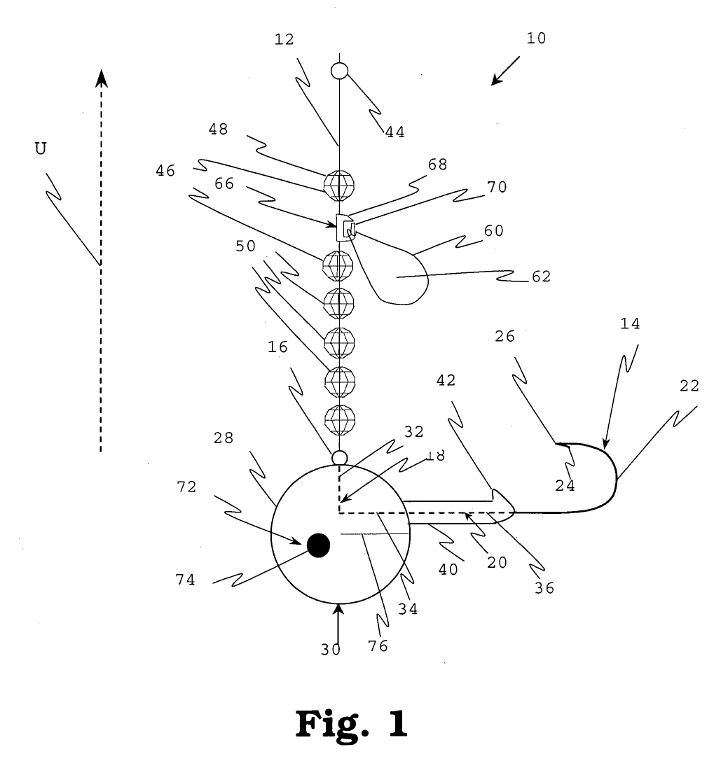

With reference to FIG. 1, a jig lure assembly 10 in accordance with the present invention includes a fishing leader line 12 and a hook 14. The fishing leader line 12 extends in an upward vertical direction as is generally indicated by arrow U. The hook 14 includes a vertical attachment portion 18 for attaching the jig lure assembly 10 to the fishing leader line 12. The vertical attachment portion 18 may include a vertical shank portion 32 and an eye 16 of the hook 14. The eye 16 is connected to the vertical shank portion 32 and attaches the jig lure assembly 10 to the fishing leader line 12. In addition, the hook 14 of the jig lure assembly 10 includes a horizontal shank portion 20. The horizontal shank portion 20 is positioned in a substantially perpendicular manner with respect to the vertical attachment portion 18 and may be connected to the vertical attachment portion 18. For example, the horizontal shank portion 20 may be connected in a substantially perpendicular manner to the vertical shank portion 32.

As shown in FIG. 1, the hook 14 of the jig lure assembly 10 has a curved hook portion 22. The curved hook portion 22 is connected to the horizontal shank portion 20. The curved hook portion 22 extends longitudinally from an end of the horizontal shank portion 20. In addition, the curved hook portion 22 has a barb 24 and a point 26 to hook fish. The barb 24 and the point 26 optionally receive an artificial or natural bait to attract fish as well as increase the likelihood of hooking fish.

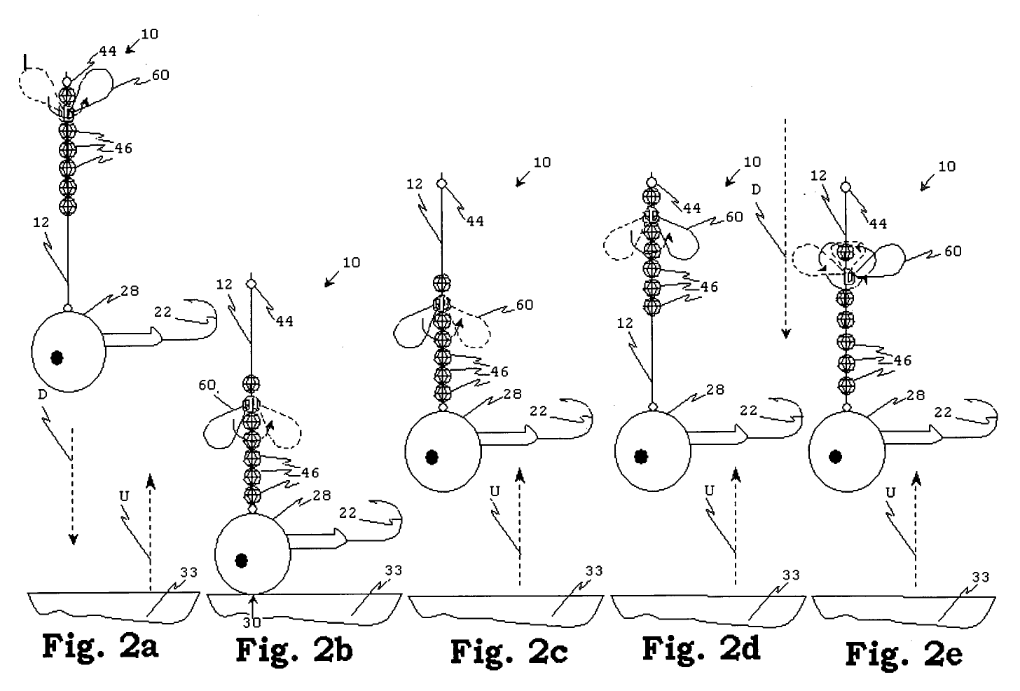

With continuing reference to FIG. 1, the jig lure assembly 10 has a generally spherical weight 28. The weight 28 may be formed of a metal such as lead, stainless-steel alloy, or some other suitable material to weigh down the jig lure assembly 10. The weight 28 has a lower curved contact surface 30. The contact surface 30 is located directly below the eye 16 of the hook 14 and the vertical attachment portion 18. Similarly, the contact surface 30 is located directly below the fishing leader line 12 that supports the jig lure assembly 10. During use of the jig lure assembly 10, the contact surface 30 may contact a water bottom surface 33 (shown in FIGS. 2a-2e) and cause the jig lure assembly 10 to jig. The water bottom surface 33 (shown in FIGS. 2a-2e) may be sand, rock, silt, coral, etcetera. The weight 28 encloses at least a portion of the vertical attachment portion 18 such that the vertical attachment portion 18 extends upwardly through and away from the weight 28. For example, the weight 28 may enclose at least a portion of the vertical shank portion 32 while leaving the eye 16 of the hook 14 unenclosed by the weight 28. Furthermore, the weight 28 encloses at least a first portion 34 of the horizontal shank portion 20 such that the horizontal shank portion 20 extends horizontally through and away from the weight 28.

As illustrated in FIG. 1, the jig lure assembly 10 includes a collar 40. The collar 40 extends horizontally away from the generally spherical weight 28. For example, the collar 40 and the horizontal shank portion 20 may extend horizontally in a substantially parallel manner with respect to a radius 76 of the weight 28. Furthermore, the collar 40 encloses at least a second portion 36 of the horizontal shank portion 20. In addition, the collar 40 has an upwardly-extending barb projection 42. The barb projection 42 may be used to secure natural or artificial bait. Alternatively, the barb projection 42 may be used to secure a guard (not shown) to reduce snagging of the curved hook portion 22 with undesirable debris. For example, the guard may include and is not limited to resilient plastic or rubber fibers, feathers and bucktail.

As shown in FIG. 1, the weight 28 optionally has indicia 72 including an eye design 74. The eye design 74 may resemble one or more eyes of a fish to attract fish to the jig lure assembly 10. For example, the eye design 74 may be two black dots positioned symmetrically about a vertical plane that bisects the weight 28 and the horizontal shank portion 20. The eye design 74 on the weight 28 may lie below the collar 40 when the fishing leader line 12 is generally axially aligned to the vertical shank portion 32.

With continuing reference to FIG. 1, the jig lure assembly 10 includes a bead stopper 44 fixedly mounted to the fishing leader line 12. The particular distance between the weight 28 and the stopper 44 may be varied to meet the desired criteria of a particular implementation. The bead stopper 44 may be displaced from the weight 28 at a distance of at least four times the diameter of the weight 28.

As shown in FIG. 1, the jig lure assembly 10 has a plurality of beads 46 rotatably and slidably mounted to the fishing leader line 12 between the stopper 44 and the weight 28. The plurality of beads 46 and the weight 28 optionally have a similarly colored pigment to attract fish. Furthermore, each of the plurality of beads 46 may be faceted to redirect light and attract fish. For example, each of the plurality of beads 46 may have thirty-two facets to redirect light and attract fish. In addition, the point 26 of the curved hook portion 22 may lie above the weight 28 and extend horizontally toward the plurality of beads 46 to increase effectiveness of the jig lure assembly 10 in hooking fish. In addition, the point 26 and the barb 24 may lie above the weight 28 to avoid snagging of the curved hook portion 22 with objects in the water such as seaweed, trees, logs, branches, rocks, brush, and other submerged objects.

As illustrated in FIG. 1, the jig lure assembly 10 has a spinner blade 60 rotatably and slidably mounted to the fishing leader line 12 between the stopper 44 and the weight 28 such that jigging of the jig lure assembly 10 causes the spinner blade 60 to rotate about the fishing leader line 12. The spinner blade 60 rotates above the weight 28 and the curved hook portion 22.

As shown in FIG. 1, the jig lure assembly 10 optionally includes a fastener 66 rotatably and slidably mounted to the fishing leader line 12 between the stopper 44 and the weight 28. The spinner blade 60 may be mounted to the fastener 66 instead of the fishing leader line 12 such that jigging of the jig lure assembly 10 causes both the spinner blade 60 and the fastener 66 to rotate contemporaneously about the fishing leader line 12. The fastener 66 may be intermediate the plurality of beads 46. For example, the plurality of beads 46 may include a first bead 48 mounted to the fishing leader line 12 above the fastener 66. In addition, the plurality of beads 46 may include lower beads 50 mounted to the fishing leader line 12 below the fastener 66. For example, the lower beads 50 may include five beads to offset the spinner blade 60 from the weight 28.

Referring to FIG. 1, the fastener 66 may be a clevis 68 having a resilient locking clasp 70 to permit exchangeability of spinner blades without removal of the clevis 68 from the fishing leader line 12. The clevis 68 may be rotatably and slidably mounted to the fishing leader line 12. The clevis 68 may be intermediate the plurality of beads 46. In addition, the clasp 70 of the clevis 68 may be made of a resilient plastic material.

With continuing reference to FIG. 1, the spinner blade 60 may be a spoon mounted to the clevis 68. The spoon has a generally convex upper surface 62 and a generally concave lower surface (not shown). The generally convex upper surface 62 of the spoon 60 generally faces upwardly from the weight 28 when the spoon 60 rotates about the fishing leader line 12. Similarly, the concave lower surface generally faces downwardly toward the weight 28 when the spoon 60 rotates about the fishing leader line 12. Furthermore, the spoon 60 may have a metallic surface or coating to reflect light and attract fish.

Referring to FIG. 2a, the spinner blade 60 may rotate about the fishing leader line 12 and slide along the fishing leader line 12 toward the bead stopper 44 as the fishing leader line 12 moves in a downward vertical direction, as is generally indicated by arrow D, toward the water bottom surface 33. In addition, the spinner blade 60 may extend in direction U and away from the bottom surface 33 due to water resistance as the weight 28 moves down toward the bottom surface 33. Movement of the spinner blade 60 above the weight 28 and the curved hook portion 22 may reflect light and enhance attraction of fish. Similarly, movement of the plurality of beads 46 may help attract fish when the beads 46 either reflect, refract or both reflect and refract light. The beads 46 may rotate about the fishing leader line 12 and slide along the fishing leader line 12 toward the bead stopper 44 as the leader line 12 moves in direction D.

As shown in FIG. 2b, the weight 28 may contact the water bottom surface 33 during use of the jig lure assembly 10. More specifically, the contact surface 30 of the weight 28 may contact the bottom surface 33 and cause the jig lure assembly 10 to jig. The bottom surface 33 may transmit an upward force through the contact surface 30 of weight 28 and cause the spinner blade 60 to rotate about the fishing leader line 12 above both the weight 28 and the curved hook portion 22. In addition, the upward force through the contact surface 30 may cause the beads 46 to move and attract fish.

As illustrated in FIG. 2c, the spinner blade 60 may rotate about the fishing leader line 12 and slide along the fishing leader line 12 toward the weight 28 as the leader line 12 moves in the upward vertical direction U. Furthermore, the spinner blade 60 may extend generally in the downward vertical direction D due to water resistance as the leader line 12 moves away the bottom surface 33. Movement of the spinner blade 60 above both the weight 28 and the curved hook portion 22 enhances attraction of fish to the jig lure assembly 10 and increases the likelihood of hooking fish on the curved hook portion 22. In addition, the spinner blade 60 being in a closer position to the weight 28 may further enhance attraction of fish to the jig lure assembly 10 and increase the likelihood of hooking fish on the curved hook portion 22. Similarly, the plurality of beads 46 may rotate about the fishing leader line 12 and slide along the fishing leader line 12 toward the weight 28 as the fishing leader line 12 moves in direction U. Rotational movement and vertical movement of the plurality of beads 46 may help attract fish and hook fish.

With reference to FIG. 2d, the plurality of beads 46 and the spinner blade 60 may slide along the fishing leader line 12 toward the bead stopper 44 when the fishing leader line 12 decelerates in the upward vertical direction U. When the fishing leader line 12 decelerates in the upward vertical direction U, the spinner blade 60 and beads 46 may rotate up toward the bead stopper 44 and away from the weight 28 to attract fish.

As shown in FIG. 2e, the plurality of beads 46 and the spinner blade 60 may slide along the fishing leader line 12 in the downward vertical direction D as the leader line 12 suspends the stopper 44 and the weight 28 in the water and the beads 46 and blade 60 accelerate toward the water bottom surface 33. The spinner blade 60, the beads 46 or both the spinner blade 60 and the beads 46 may rotate above the weight 28 and the curved hook portion 22 as the spinner blade 60 and beads 46 slide along the leader line 12 and attract fish.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A jig lure assembly for attachment to a fishing line, the jig lure assembly comprising:
a fishing leader line;
a vertical attachment portion for attaching the jig lure assembly to the fishing leader line;
a horizontal shank portion positioned in a substantially perpendicular manner with respect to the vertical attachment portion;
a curved hook portion extending longitudinally from an end of the horizontal shank portion and having a barb and a point to hook fish;
a generally spherical weight enclosing at least a portion of the vertical attachment portion and the horizontal shank portion such that the vertical attachment portion extends upwardly through the weight;
a bead stopper mounted to the fishing leader line;
a plurality of beads rotatably and slidably mounted to the fishing leader line between the stopper and the weight; and
a spinner blade rotatably and slidably mounted to the fishing leader line between the stopper and the weight such that jigging of the jig lure assembly causes the spinner blade to rotate about the fishing leader line.

2. A jig lure assembly for attachment to a fishing line, the jig lure assembly comprising:
a fishing leader line;
a hook having an eye for attaching the jig lure assembly to the fishing leader line, a vertical shank portion connected to the eye, a horizontal shank portion connected in a substantially perpendicular manner to the vertical shank portion, and a curved hook portion connected to the horizontal shank portion and having a barb and a point to hook fish;
a generally spherical weight having a lower curved contact surface located directly below the eye of the hook and the vertical shank portion as well as the fishing leader line supporting the jig lure assembly, the weight enclosing at least a portion of the vertical shank portion and at least a first portion of the horizontal shank portion such that the vertical shank portion extends upwardly through the weight and the horizontal shank portion extends horizontally through and away from the weight;
a collar extending horizontally from the weight and enclosing at least a second portion of the horizontal shank portion, and the collar having an upwardly-extending barb projection;
a bead stopper fixedly mounted to the fishing leader line;
a plurality of beads rotatably and slidably mounted to the fishing leader line between the stopper and the weight; and
a spinner blade rotatably and slidably mounted to the fishing leader line between the stopper and the weight such that jigging of the jig lure assembly causes the spinner blade to rotate about the fishing leader line.

3. The jig lure assembly of claim 2, the lure further comprising a fastener rotatably and slidably mounted to the fishing leader line between the stopper and the weight, the spinner blade being mounted to the fastener such that jigging of the jig lure assembly causes the spinner blade and the fastener to rotate about the fishing leader line.

4. The jig lure assembly of claim 3, wherein the fastener is intermediate the plurality of beads.

5. The jig lure assembly of claim 3, wherein the plurality of beads includes a first bead mounted to the fishing leader line above the fastener and lower beads mounted to the fishing leader line between the weight and the fastener.

6. The jig lure assembly of claim 5, wherein the lower beads include at least five beads to offset the spinner blade from the generally spherical weight.

7. The jig lure assembly of claim 2, wherein the weight and the plurality of beads have a similarly colored pigment to attract fish.

8. The jig lure assembly of claim 2, wherein each of the plurality of beads is faceted to redirect light and attract fish.

9. The jig lure assembly of claim 2, wherein each of the plurality of beads has thirty-two facets to redirect light and attract fish.

10. The jig lure assembly of claim 2, wherein the fastener is a clevis having a resilient locking clasp to permit exchangeability of spinner blades without removal of the clevis from the fishing leader line.

11. The jig lure assembly of claim 2, wherein the spinner blade is a spoon that extends upwardly when the spoon rotates about the fishing leader line.

12. The jig lure assembly of claim 11, wherein the spoon has a generally convex upper surface and a generally concave lower surface, and wherein the concave lower surface faces downwardly when the spoon rotates about the fishing leader line.

13. The jig lure assembly of claim 11, wherein the spoon has a metallic surface to reflect light and attract fish.

14. The jig lure assembly of claim 2, wherein the point of the curved hook portion lies above the weight and extends substantially horizontally toward the plurality of beads.

15. The jig lure assembly of claim 2, wherein the collar and the horizontal shank portion extend from the weight in a substantially parallel manner with respect to a radius of the generally spherical weight.

16. The jig lure assembly of claim 2, wherein the bead stopper is displaced from the weight at a length of at least four times a diameter of the weight.

17. The jig lure assembly of claim 2, wherein the weight has indicia including an eye design.

18. The jig lure assembly of claim 17, wherein the eye design lies below the collar when the fishing leader line is generally axially aligned to the vertical shank portion.

19. A jig lure assembly for attachment to a fishing line, the jig lure assembly comprising:
a fishing leader line;
a hook having an eye for attaching the jig lure assembly to the fishing leader line, a vertical shank portion connected to the eye, a horizontal shank portion connected in a substantially perpendicular manner to the vertical shank portion, and a curved hook portion connected to the horizontal shank portion and having a barb and a point to hook fish;
a generally spherical weight having a lower curved contact surface located directly below the eye of the hook and the vertical shank portion as well as the fishing leader line supporting the jig lure assembly, the weight enclosing at least a portion of the vertical shank portion and at least a first portion of the horizontal shank portion such that the vertical shank portion extends upwardly through and away from the weight and the horizontal shank portion extends horizontally through and away from the weight;
a collar extending horizontally from the generally spherical weight in a substantially parallel manner from a radius of the weight, the collar enclosing at least a second portion of the horizontal shank portion and having an upwardly-extending barb projection;
a bead stopper fixedly mounted to the fishing leader line;
a plurality of beads rotatably and slidably mounted to the fishing leader line between the stopper and the weight;
a clevis rotatably and slidably mounted to the fishing leader line intermediate the plurality of beads; and
a spoon mounted to the clevis such that jigging of the jig lure assembly causes the spoon and the clevis to rotate about the fishing leader line.
